(19) United States
(12) Patent Application Publication
(10) Pub. No.: US 2012/0244346 A1
(43) Pub. Date: Sep. 27, 2012

(54) FUSING COMPOSITION COMPRISING CROSS-LINKING FLUOROCARBONS

(75) Inventors: Carolyn Moorlag, Mississauga (CA); Nan-Xing Hu, Oakville (CA); Yu Qi, Oakville (CA); Qi Zhang, Mississauga (CA)

(73) Assignee: XEROX CORPORATION, Norwalk, CT (US)

(21) Appl. No.: 13/069,229

(22) Filed: Mar. 22, 2011

(51) Int. Cl. B32B 17/10; C08F 220/12; B32B 13/04; B32B 15/04; G03G 15/20; B05D 3/12

(52) U.S. Cl. 428/339; 524/858; 399/333; 427/387; 427/359; 427/368; 427/240; 428/447; 428/446; 428/450

(57) ABSTRACT

Novel compositions for use in image forming apparatus and fuser members. In particular, the novel composition is a hybrid networked material comprising fluorocarbon chains connected via silane linkages. The novel composition may be used in fuser members comprising a substrate and a top-coat layer disposed over the substrate.

### BACKGROUND

The present embodiments relate to material compositions, and more particularly, to novel compositions for use in image forming apparatus and fuser members.

In an electrophotographic printing process, a toner image on a media is fixed by feeding the media through a nip formed by a fuser member and a pressure member in a fuser subsystem and heating the fusing nip, such that the toner image on the media contacts a surface of the fuser member. The heating causes the toner to become tacky and adhere to the media. However, the toner particles of the toner image can stick to the fuser member besides adhering to the media, resulting in an image offset. If the offset image on the fuser is not cleaned, it may print onto the medium in the next revolution and result in unwanted image defects on the print. In order to overcome the problems faced during the fusing process, fuser members include top-coat materials typically comprised of low surface energy fluoropolymers such as perfluoroalkoxy polymer resin (PFA) (also known under the tradename TEFLON) and fluoroelastomers (also known under the tradename VITON). These materials are expected to provide heat and wear resistance, conformability, and release at the fusing nip. However, these materials are also associated with end-use application issues, such as performance problems. For example, PFA coatings tend to undergo surface damage and require high temperatures for processing while fluoroelastomers provide insufficient release with the use of polydimethylsiloxane (PDMS)-based fusing oils for release.

As such, there is great interest in finding new compositions for use in fuser members that would significantly improve the properties and performance of the fuser member. In particular, there is a need for new fusing compositions that are low surface energy, improved robustness to surface damage (e.g., dents or wounds), toner releasing, and can provide oil-less fusing. Furthermore, it would be desirable that the new fusing composition can be processed by feasible processing techniques.

Thus, there is a need to overcome the problems of the prior art and to provide material compositions with improved thermal, mechanical and/or electrical properties for fuser members used in electrophotographic printing devices and processes.

Each of the U.S. Patents and Patent Publications mentioned herein are incorporated by reference herein. Further, the appropriate components and process aspects of the each of the U.S. Patents and Patent Publications may be selected for the present disclosure in embodiments thereof.

### SUMMARY

According to the embodiments, there is provided a hybrid networked material comprising fluorocarbon chains that are connected via silane linkages. The present networked (crosslinked) coatings are useful for fusing applications by incorporating fluorocarbon chains comprising a significant portion of fluorine content to allow for release. These coatings can be used for coating fuser members, for example, as a top-coat layer.

In particular, the present embodiments provide a release coating composition comprising: a crosslinking network of fluorinated organic chains; and organosilane compounds. In embodiments, the fluorine content of the composition is greater than 50 percent and further wherein the composition does not contain silicon-oxygen bonding.

In further embodiments, there is provided a fuser member comprising: a substrate; and a top-coat layer disposed on the substrate, wherein the top-coat layer comprises a crosslinking network of fluorinated organic chains, and organosilane compounds. In embodiments, the fluorine content of the top-coat layer is greater than 50 percent and further wherein the top-coat layer does not contain silicon-oxygen bonding.

In yet other embodiments, there is provided a method for providing a coating composition for a fuser member, comprising: providing a perfluorohexadiene and an organic compound having siloxane in the compound in a medium comprising a catalytic amount of a heterogeneous platinum group metal catalyst that is catalytically active towards hydrosilylation; carrying out the hydrosilylation reaction in the medium to produce a composition comprising the hydrosilylation reaction product of the perfluorohexadiene and the organic compound having silane in the compound.

### BRIEF DESCRIPTION OF THE DRAWINGS

For a better understanding of the present embodiments, reference may be had to the accompanying figures.

FIG. 1 schematically illustrates an exemplary printing apparatus, according to the present embodiments;

FIG. 2 schematically illustrates a cross-section of an exemplary fuser member as shown in FIG. 1, according to the present embodiments;

FIG. 3A illustrates a perfluorodiene reaction with silane precursors producing a coating comprising cross-linking fluorocarbons according to the present embodiments;

FIG. 3B illustrates an alternative perfluorodiene reaction with silane precursors producing a coating comprising cross-linking fluorocarbons according to the present embodiments; and

FIG. 3C illustrates an alternative perfluorodiene reaction with silane precursors producing a coating comprising cross-linking fluorocarbons according to the present embodiments.

### DETAILED DESCRIPTION

In the following description, it is understood that other embodiments may be utilized and structural and operational changes may be made without departure from the scope of the present embodiments disclosed herein.

The present embodiments relate to material compositions, and more particularly, to novel compositions for use in image forming apparatus and fuser members.

The material composition of the present embodiments is a hybrid networked material comprising fluorocarbon chains that are connected via silane linkages. The present networked (crosslinked) coatings are useful for fusing applications by incorporating fluorocarbon chains comprising a significant portion of fluorine content to allow for release. These coatings can be used for coating fuser members, for example, as a top-coat layer. The advantages of this networked coating is that one or a few components can be used to reactively form a robust coating via low temperature processing, and the intrinsic properties of the materials system can be tuned. In addition, a networked coating avoids substrate degradation issues associated with high temperature (>300° C.) processing required to melt PFA. Silicone rubber substrate begins to degrade at around 250° C. Consequently, the properties of the composition of the present embodiments is especially useful in image forming apparatus and fuser members which endure constant processing and high heat.

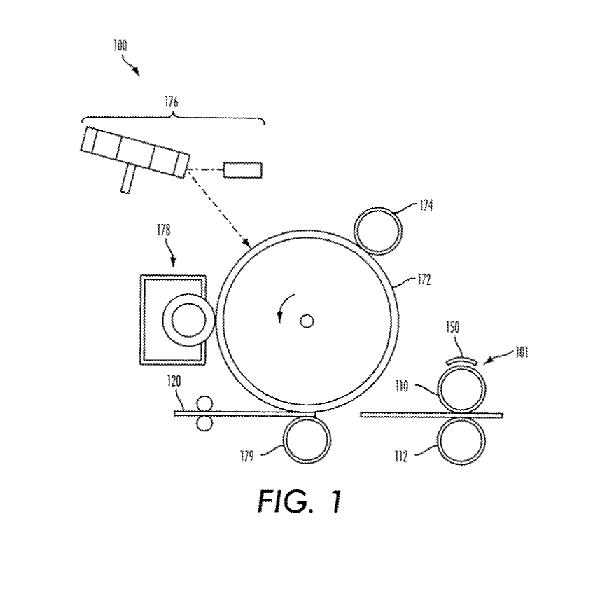

FIG. 1 schematically illustrates an exemplary printing apparatus 100. The exemplary printing apparatus 100 can include an electrophotographic photoreceptor 172 and a charging station 174 for uniformly charging the electrophotographic photoreceptor 172. FIG. 1 is meant to be merely illustrative of one embodiment and thus is not limited to only drum photoreceptors. The electrophotographic photoreceptor 172 can be a drum photoreceptor as shown in FIG. 1 or a belt photoreceptor (not shown). The exemplary printing apparatus 100 can also include an imaging station 176 where an original document can be exposed to a light source for forming a latent image on the electrophotographic photoreceptor 172. The exemplary printing apparatus 100 can further include a development subsystem 178 for converting the latent image to a visible image on the electrophotographic photoreceptor 172 and a transfer subsystem 179 for transferring the visible image onto a media 120. The printing apparatus 100 can also include a fuser subsystem 101 for fixing the visible image onto the media 120. The fuser subsystem 101 can include one or more of a fuser member 110, a pressure member 112, oiling subsystems (not shown), and a cleaning web (not shown), wherein the fuser member and/or the pressure member 112 can have a top-coat layer including a crosslinked network of fluorocarbons connected by silane linkages. In some embodiments, the fuser member 110 can be a fuser roll 110, as shown in FIG. 1. In other embodiments, the fuser member 110 can be a fuser belt, 515, as shown in FIG. 5. In various embodiments, the pressure member 112 can be a pressure roll 112, as shown in FIG. 1 or a pressure belt (not shown).

The fuser member can include a substrate having one or more functional layers formed thereon. The substrate can include, e.g., a cylinder or a belt. The one or more functional layers includes an outermost or top silicon textured surface having a surface wettability that is hydrophobic and/or oleophobic; ultrahydrophobic and/or ultraoleophobic; or superhydrophobic and/or superoleophobic by forming textured features in the silicon. Such a fuser member can be used as an oil-less fusing member for high speed, high quality electrophotographic printing to ensure and maintain a good toner release from the fused toner image on an image supporting material (e.g., a paper sheet), and further assist paper stripping. In another embodiment, the silicon textured surface can provide an oil-free, such as wax-free, toner design for the oil-less fixing process.

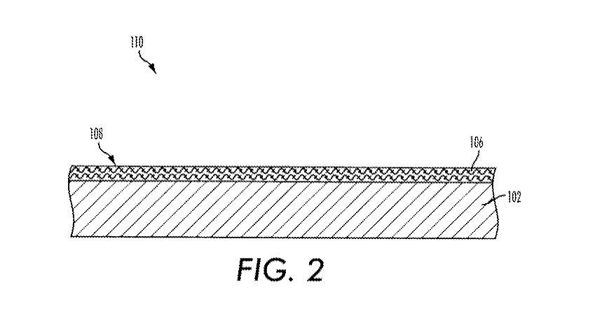

Referring back to the fuser member 110 as shown in FIGS. 1 and 2, the substrate 102 may be composed of polymeric materials (e.g., polyimide, polyaramide, polyether ether ketone, polyetherimide, polyphthalamide, polyamide-imide, polyketone, polyphenylene sulfide, fluoropolyimides or fluoropolyurethanes) or metal materials (e.g., aluminum or stainless steel) to maintain rigidity and structural integrity as known to one of ordinary skill in the art. The substrate can further be a high temperature plastic substrate, such as, for example, polyimide, polyphenylene sulfide, polyamide imide, polyketone, polyphthalamide, polyetheretherketone (PEEK), polyethersulfone, polyetherimide, and polyaryletherketone. The substrate can be formed in various shapes, e.g., a cylinder (e.g., a cylinder tube), a cylindrical drum, a roll, a belt, or a film, using suitable materials that are non-conductive or conductive depending on a specific configuration. The thickness of the substrate 102 in a belt configuration can be from about 50 μm to about 300 μm, and in some cases from about 50 μm to about 100 μm. The thickness of the substrate 102 in a cylinder or a roll configuration can be from about 2 mm to about 20 mm, and in some cases from about 3 mm to about 10 mm.

Examples of functional layers include fluorosilicones, silicone rubbers such as room temperature vulcanization (RTV) silicone rubbers, high temperature vulcanization (HTV) silicone rubbers, and low temperature vulcanization (LTV) silicone rubbers. These rubbers are known and readily available commercially, such as SILASTIC®735 black RTV and SILASTIC® 732 RTV, both from Dow Corning; 106 RTV Silicone Rubber and 90 RTV Silicone Rubber, both from General Electric; and JCR6115CLEAR HTV and SE4705U HTV silicone rubbers from Dow Corning Toray Silicones. Other suitable silicone materials include the siloxanes (such as polydimethylsiloxanes); fluorosilicones such as Silicone Rubber 552, available from Sampson Coatings, Richmond, Va.; liquid silicone rubbers such as vinyl crosslinked heat curable rubbers or silanol room temperature crosslinked materials; and the like. Another specific example is Dow Corning Sylgard 182. Commercially available LSR rubbers include Dow Corning Q3-6395, Q3-6396, SILASTIC® 590 LSR, SILASTIC® 591 LSR, SILASTIC® 595 LSR, SILASTIC® 596 LSR, and SILASTIC® 598 LSR from Dow Corning. The functional layers provide elasticity and can be mixed with inorganic particles, for example SiC or Al₂O₃, as required.

Examples of functional layers also include fluoroelastomers. Fluoroelastomers are from the class of 1) copolymers of two of vinylidenefluoride, hexafluoropropylene, and tetrafluoroethylene; 2) terpolymers of vinylidenefluoride, hexafluoropropylene, and tetrafluoroethylene; and 3) tetrapolymers of vinylidenefluoride, hexafluoropropylene, tetrafluoroethylene, and cure site monomer. These fluoroelastomers are known commercially under various designations such as VITON A®, VITON B®, VITON E®, VITON E 60C®, VITON E430®, VITON 910®, VITON GH®; VITON GF®; and VITON ETP®. The VITON® designation is a Trademark of E.I. DuPont de Nemours, Inc. The cure site monomer can be 4-bromoperfluorobutene-1,1,1-dihydro-4-bromoperfluorobutene-1,3-bromoperfluoropropene-1,1,1-dihydro-3-bromoperfluoropropene-1, or any other suitable, known cure site monomer, such as those commercially available from DuPont. Other commercially available fluoropolymers include FLUOREL 2170®, FLUOREL 2174®, FLUOREL 2176®, FLUOREL 2177® and FLUOREL LVS 76®, FLUOREL® being a registered trademark of 3M Company. Additional commercially available materials include AFLAS™ a poly(propylene-tetrafluoroethylene) and FLUOREL II® (LII900) a poly(propylene-tetrafluoroethylenevinylidenefluoride) both also available from 3M Company, as well as the Tecnoflons identified as FOR-60KIR®, FOR-LHF®, NM® FOR-THF®, FOR-TFS®, TH®, NH®, P757®, INS®, T439®, PL958®, BR9151® and TN505®, available from Ausimont.

Examples of three known fluoroelastomers are (1) a class of copolymers of two of vinylidenefluoride, hexafluoropropylene, and tetrafluoroethylene, such as those known commercially as VITON A®; (2) a class of terpolymers of vinylidenefluoride, hexafluoropropylene, and tetrafluoroethylene known commercially as VITON B®; and (3) a class of tetrapolymers of vinylidenefluoride, hexafluoropropylene, tetrafluoroethylene, and cure site monomer known commercially as VITON GH® or VITON GF®.

The fluoroelastomers VITON GH® and VITON GF® have relatively low amounts of vinylidenefluoride. The VITON GF® and VITON GH® have about 35 weight percent of vinylidenefluoride, about 34 weight percent of hexafluoropropylene, and about 29 weight percent of tetrafluoroethylene, with about 2 weight percent cure site monomer.

Additives and additional conductive or non-conductive fillers may be present in the substrate or functional layers. In various embodiments, other filler materials or additives including, for example, inorganic particles, can be used for the coating composition and the subsequently formed surface layer. Conductive fillers used herein may include carbon blacks such as carbon black, graphite, fullerene, acetylene black, fluorinated carbon black, and the like; carbon nanotubes; metal oxides and doped metal oxides, such as tin oxide, antimony dioxide, antimony-doped tin oxide, titanium dioxide, indium oxide, zinc oxide, indium oxide, indium-doped tin trioxide, and the like; and mixtures thereof. Certain polymers such as polyanilines, polythiophenes, polyacetylene, poly(p-phenylene vinylene), poly(p-phenylene sulfide), pyrroles, polyindole, polypyrene, polycarbazole, polyazulene, polyazepine, poly(fluorine), polynaphthalene, salts of organic sulfonic acid, esters of phosphoric acid, esters of fatty acids, ammonium or phosphonium salts and mixtures thereof can be used as conductive fillers. In various embodiments, other additives known to one of ordinary skill in the art can also be included to form the disclosed composite materials.

For a roller configuration, the thickness of the functional layer can be from about 0.5 mm to about 10 mm, or from about 1 mm to about 8 mm, or from about 2 mm to about 7 mm. For a belt configuration, the functional layer can be from about 25 microns up to about 2mm, or from 40 microns to about 1.5 mm, or, from 50 microns to about 1 mm.

In various embodiments, the fuser member 110 can also include one or more optional adhesive layers; the optional adhesive layers can be disposed between the substrate 102 and the top-coat layer 108. Exemplary materials for the optional adhesive layer can include, but are not limited to epoxy resins and polysiloxanes. The adhesive layer can be coated on the substrate, or on the outer layer, to a thickness of from about 2 nanometers to about 10,000 nanometers, or from about 2 nanometers to about 1,000 nanometers, or from about 2 nanometers to about 5000 nanometers. The adhesive can be coated by any suitable known technique, including spray coating or wiping.

Referring back to the printing apparatus 100, the printing apparatus 100 can be a xerographic printer, as shown in FIG. 1. Referring back to the fuser member 110, FIG. 2 schematically illustrates a cross section of an exemplary fuser member 110. In various embodiments, the exemplary fuser member 110 can include a top-coat layer 108 disposed over a substrate 102. The top-coat layer 108 comprises a hybrid networked material 106 comprised of fluorocarbon chains connected via silane linkages. The networked material 106 is substantially uniformly dispersed throughout the bulk of the top-coat layer 108 and provides a low surface energy surface that exhibits robustness to surface damage and good release without the need for an additional fuser oil. Thus, the fuser member of the present embodiments has a self-releasing surface. As used herein, the term “self-releasing surface” refers to a surface that release media with a minimal amount of fusing oil, or without the use of fusing oil. In embodiments, the top-coat layer has a thickness of from about 10 μm to about 100 μm, or of from about 20 μm to about 40 μm.

As discussed above, the composition of the present embodiments iσ a crosslinked material comprising of fluorocarbon chains connected via silane linkages. The coatings made from the composition are useful for fusing applications by incorporating fluorocarbon chains comprising a significant portion of fluorine content to allow for release. The coatings include chemically and thermally stable silane linkages that will not degrade under fusing conditions. For example, the networked coating composition avoids substrate degradation issues associated with high temperature (>300° C.) processing required to melt PFA. Further advantages of this networked or crosslinked coating is that one or a few components can be used to reactively form a robust coating via low temperature processing, and the intrinsic properties of the materials system can be tuned.

Moreover, silane linkages are chemically stable, mechanically robust linkages that may be used to form linear or branched extended structures. Extensive networking of fluorocarbon chains via silane linkages yield a highly chemically bound material system. The significant crosslinking of the fluorocarbon network via silane linkages thus results in a material with high toughness as well as flexibility due to flexible chains, branching, and the amorphous character of the system. Furthermore, the fluorocarbon chains provide high fluorine content to provide good release at the surface.

As such, the silane-linked fluorocarbon network of the present embodiments provides a new material for applications such as high performance fusing. The novel composition provides advantages for fusing over conventional fusing materials such as, for example: (1) a more robust surface that is less prone to surface damage, (2) relatively low temperature processing (i.e., <250° C.) compared with PFA (>300° C.), (3) chemical and thermal stability of fluorosilanes, and (4) a tunable materials system.

The cross-linking fluorocarbon coatings are expected to display decreasing calculated surface energy with increasing fluorocarbon chain length, as is known to occur for other fluorocarbon-containing coatings. The coatings formed from this material are flexible, and bond well to silicone substrates. High fluorine content coatings made of these materials are expected to demonstrate good release with wax-containing toner. In general, the coating compositions of the present embodiments comprise a crosslinking network of fluorinated organic chains, and organosilane compounds. The organosilane compounds may be fluorinated or non-fluorinated. The fluorinated organic chains are crosslinked through hydrosilylation reactions to form a crosslinked network. In specific embodiments, the cross-linking network of fluorocarbons is formed from fluorinated organic chains comprising perfluorobutadiene, perfluorohexadiene, or perfluorooctadiene; and organosilanes comprising perfluorohexadisilanes, or tetraallylsilane; or mixtures thereof.

When used in fuser members, the coating compositions of the present embodiments provide fuser member that exhibit higher wear resistance than a fuser member not including the crosslinking network of fluorinated organic chains connected by silane linkages. Likewise, when used in fuser members, the coating compositions of the present embodiments provide fuser member that exhibit higher higher chemical and thermal stability during fusing than a fuser member not including the crosslinking network of fluorinated organic chains connected by silane linkages. Wear can be quantified as material damage occurring on the surface of a fuser member that results in a defect being shown on the image of the printed surface. The reduction in susceptibility of the topcoat to material damage can be defined as “wear resistance”. Chemical stability can be defined as resistance to reaction with water or air, which silane-linked materials are known to be resistant to. Thermal stability refers to chemical linkages breaking or decomposing at fusing temperature over repeated cycles of fusing. A topcoat must be thermally stable for application as a fusing material.

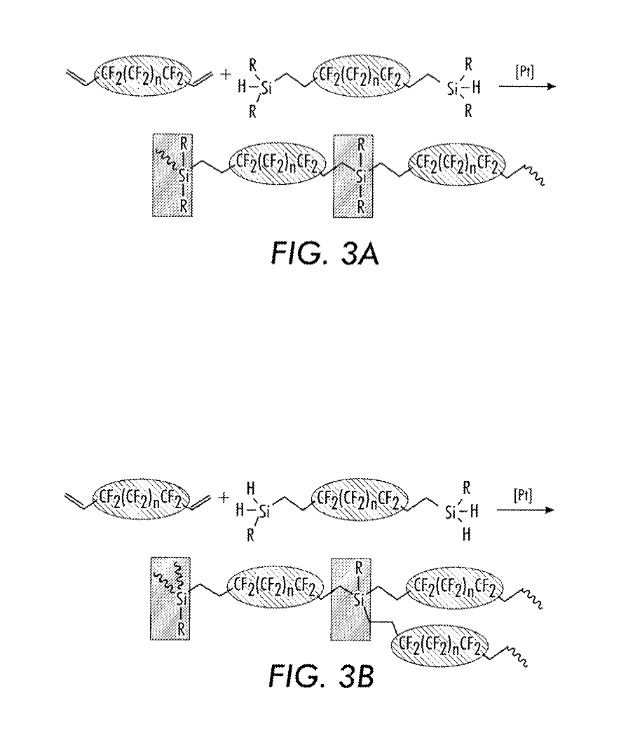

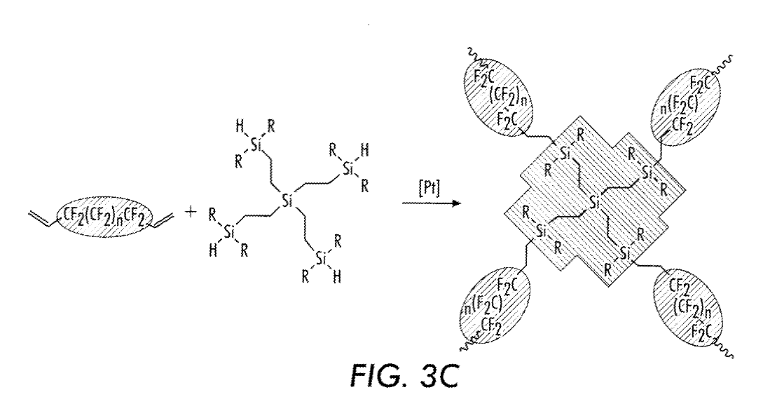

The above-mentioned problems may be avoided with the cross-linking fluorocarbon coating. With the cross-linking fluorocarbon coatings, there would not be shrinkage during curing that can result in material defects and susceptibility to materials damage while fusing. Crosslinking via silane linkages contributes to mechanical strength of the material and improved wear resistance. Crosslinking via silane linkages also contributes to chemical and thermal stability. The present embodiments thus provide a new class of networked coatings with high fluorine content of greater than 50 percent that would produce a high hot offset temperature and provide good release during oil-less fusing. FIGS. 3A, 3B and 3C illustrate perfluorodiene reactions with silane precursors for use in a coating comprising cross-linking fluorocarbons according to the present embodiments. FIGS. 3A, 3B and 3C present perfluorodiene reactions with silane precursors. The resulting product comprises fluorinated chains (as indicated by oval shading) connected via silane linkages (as indicated by rectangular shading).

FIG. 3A illustrates a reaction producing linear chains formed with tertiary disilanes. These systems are linear and not strictly cross-linked. Branching systems such as are described in FIGS. 3B and 3C must be included in order to produce a cross-linked system. FIG. 3B illustrates a reaction producing a branched network formed with secondary disilanes. FIG. 3C illustrates a reaction producing a branched network formed with pentasilane. These reaction schemes are merely illustrative and are not intended to cover all reactions contemplated by the present embodiments. In addition, all three schemes may be combined to form a mixed system in some embodiments.

As discussed, the present embodiments provide a composition that is a hybrid networked material comprising fluorocarbon chains connected via silane linkages. Silane linkages are chemically stable, mechanically robust linkages that may be used to form linear or branched extended structures. The present embodiments make use of hydrosilylation reactions across double-bonded segments to crosslink fluorocarbon chains into a network. Hydrosilylation reactions are advantageous because they do not form bi-products that can degrade fusing performance by promoting contamination at the fusing surface. Cross-linking via hydrosilylation reactions is additionally advantageous due to no material loss during network formation that can result in shrinkage, therefore minimizing cracking or other defects that may be formed on the fusing topcoat layer for materials that substantially shrink. The low shrinkage of the present materials also allow for variation of thickness.

A networked system requires the introduction of multifunctional or branched components. For example, while tertiary disilanes form only linear chains with perfluorodienes, a secondary disilane may form branched segments to yield a crosslinked system, as shown in FIG. 3B and discussed in Larry N. Lewis et al., Hydrosilylation Catalyzed by Metal Colloids: A Relative Activity Study, Organometallics 9:621-625 (1990), which is hereby incorporated by reference in its entirety. Alternatively, a branched silane such as the pentasilane shown may be reacted with perfluorodienes to form a fully branched network structure, as shown in FIG. 3C and discussed in Francesc Teixidor et al., Modular Construction of Neutral and Anionic Carboranyl-Containing Carbosilane-Based Dendrimers, Macromolecules 40:5644-5652 (2007), which is hereby incorporated by reference in its entirety. Besides being robust and flexible, the present embodiments can be tuned for meeting certain parameters. For the purpose of tuning crosslinking, flexibility, and mechanical strength of the system, the three hydrosilylation reactions shown may be combined in varying ratios. More specifically, materials and surface properties may be tuned by choice of fluorocarbon and/or silane precursors.

Significant fluorine content in the network is required to provide release at the fusing surface. An advantage of a silane-linked system is relatively low incorporation of linkage components, so that the fluorine content of potential networks is generally greater than 50 percent, as shown in Table 2. In particular embodiments, the fluorine content is from about 50 to about 70 percent. The fluorine content may be further increased by the use of extended fluorocarbon chains, or the incorporation of monofunctional fluorocarbon chains capable of bonding into the system and forming fluorocarbon “hairs” that can significantly reduce surface energy. Table 2 demonstrates the calculated fluorine content and degree of branching using perfluorohexadiene and various silane precursors.

TABLE 2

| 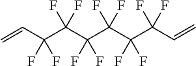 | 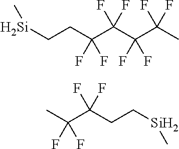 | 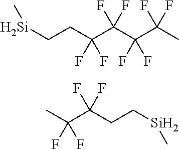 | 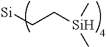 | Fluorine Content | Network Structure |
|---|---|---|---|---|---|
| 1 | 0.5 | 0 | 0 | 59.5 | Fully |
| | | | | | Branched |
| 1 | 0 | 1 | 0 | 55 | Linear |
| | | | | | Chain |
| 1 | 0.25 | 0.5 | 0 | 57 | Partially |
| | | | | | Branched |
| 1 | 0 | 0.5-0.8 | 0.1-0.25 | 54-51 | Partially |
| | | | | | Branched |
| 1 | 0 | 0 | 0.5 | 46 | Fully |
| | | | | | Branched |

The crosslinking network described does not contain any components containing siloxanes, such as polydimethylsiloxanes, polydiethylsiloxanes, polydivinylsiloxanes, or other polymerized or oligomerized siloxanes. Siloxanes are characterized by the presence of silicon-oxygen (Si—O) bonds that may be present singly or in repeated chains such as in the case of polymerized or oligomerized siloxanes. The crosslinking network is also free from crosslinkers containing siloxane functionalities, including amino silanes such as AO700 (N-(2-aminoethyl)-3-aminopropyltrimethoxysilane), 3-(N-strylmethyl-2-aminoethylamino)propyltrimethoxy silane hydrochloride and (aminoethylamino methyl) phenethytrimethoxysilane. It is desirable to form a composition without the presence of siloxanes, as they can be subject to hydrolysis.

In embodiments, there is provided a method for providing a coating composition for a fuser member which comprises carrying out a hydrosilylation reaction in a medium comprising a catalyst. For example, the medium comprises a catalytic amount of a heterogeneous platinum group metal catalyst that is catalytically active towards hydrosilylation. A fluorocarbon, such as perfluorohexadiene, and an organic compound having siloxane in the compound are added to the medium to carryout the hydrosilylation reaction in the medium. Subsequently, the catalyst is removed from the medium to produce a composition comprising the hydrosilylation reaction product.

The method of making a member of a fuser subsystem can further include a step of applying the coating composition of the present embodiments over the substrate to form a coated substrate. Any suitable technique can be used for applying the dispersion to the one region of the substrate, such as, for example, spray coating, dip coating, brush coating, roller coating, spin coating, casting, flow coating, and other coating methods.

Precursors could be combined neat, or in solution, with the appropriate hydrosilylation catalyst. Following coating, the reactive mixture is crosslinked and cured upon heat treatment. Precursors may be alternatively partially reacted and crosslinked before coating. The silane-linked coating can react directly with the substrate of a roll or belt, for example, a silicone substrate, resulting in a primer-free fuser member top-coat.

The method can also include a step of curing the coated substrate to form a top-coat layer over the substrate and a step of polishing the top-coat layer so that a continual self-releasing surface is formed at a surface of the top-coat layer. In various embodiments, curing can be done in the range of about 40° C. to about 400° C. The curing step may be performed for about 20 to about 300 minutes. Any suitable polishing method can be used, such as, for example mechanical polishing with a pad.

In certain embodiments, the step of applying the coating composition over the substrate to form a coated substrate can include forming a compliant layer over the substrate and applying the coating composition over the compliant layer to form a coated substrate. Any suitable material can be used to form the compliant layer, including, but not limited to, silicones, fluorosilicones, and a fluoroelastomers.

It will be appreciated that various of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art, and are also intended to be encompassed by the following claims.

While the description above refers to particular embodiments, it will be understood that many modifications may be made without departing from the spirit thereof. The accompanying claims are intended to cover such modifications as would fall within the true scope and spirit of embodiments herein.

The presently disclosed embodiments are, therefore, to be considered in all respects as illustrative and not restrictive, the scope of embodiments being indicated by the appended claims rather than the foregoing description. All changes that come within the meaning of and range of equivalency of the claims are intended to be embraced therein.

### EXAMPLES

The examples set forth herein below and are illustrative of different compositions and conditions that can be used in practicing the present embodiments. All proportions are by weight unless otherwise indicated. It will be apparent, however, that the present embodiments can be practiced with many types of compositions and can have many different uses in accordance with the disclosure above and as pointed out hereinafter.

### Example 1

Preparation of Disilylperfluorocarbon Precursors

Synthesis of fluorocarbon silane precursors was carried out for the purpose of preparing fluorinated silanes suitable for the formation of silane-linked networked coatings. The reaction below to obtain tertiary disilylperfluorohexane, was carried out on a 5 g scale.

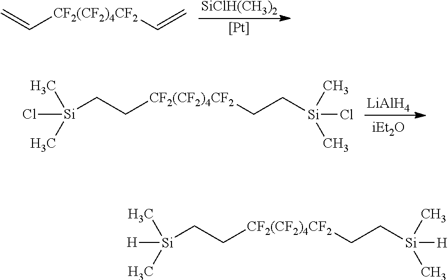

### Example 2

Preparation of Silane-Linked Fluorocarbon Chains

The hydrosilylation reaction between neat disilylperfluorohexane (0.1 g) and perfluorohexadiene (0.075 g) was carried out in the presence of 0.02% Karstedt catalyst. Time zero NMR analysis showed the presence of two starting materials, unreacted. The material was reacted at 55° C. for 16 hours while stirring. Subsequent NMR analysis showed disappearance of disilane proton, as well as shifting of methyl chemical shifts, indicating complete reaction of diene starting material. The product was a liquid with no evidence of gelation, as would be expected in the case of linear silane-linked fluorocarbon chains.

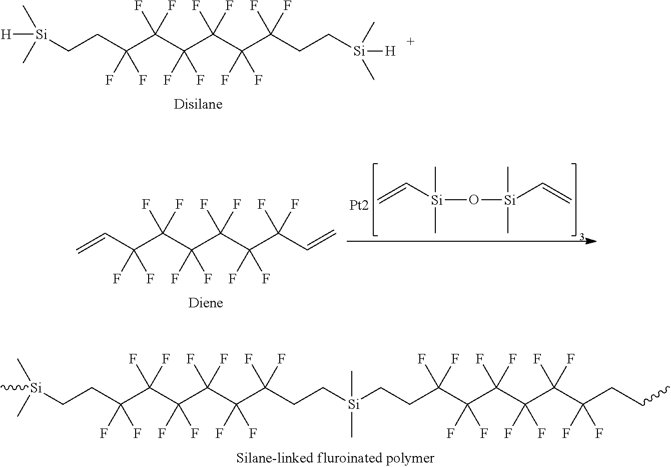

### Example 3

Networked Materials Preparation

Reactions between disilylperfluorohexane, perfluorohexadiene and tetraallylsilane were carried out via hydrosilylation reaction to obtain polymerized material containing varying degrees of branching, depending on the proportion of tetraallylsilane incorporated into the networked material.

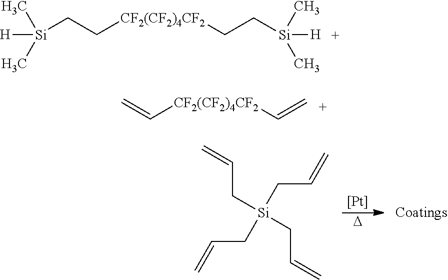

Reaction A: Mix 0.1 g disilane with 0.75 g diene, add 0.016 mg or Karstedt catalyst.

Reaction B: Mix 0.1 g disilane with 0.71 g diene, and 2 mg of tetraallylsilane, add 0.016 mg or Karstedt catalyst.

Reaction A and reaction B were combined with 7 g methyl isobutyl ketone (MIBK) to yield reaction solutions. Solutions were spray coated onto short metal rolls covered with silicone rubber substrate. The short rolls had been heat treated to 120° C. Spray coated solutions appeared to dry quickly upon contact with the heated short rolls.

The coated short rolls were heat treated in a 150° C. oven for 1 hr, then in a 200° C. oven for 1 hr, then in a 300° C. oven for 20 minutes. The resulting coating surfaces were shiny and smooth. There was not any evidence of cracking or brittleness. Adhesion to the silicone rubber surface appeared to be robust to rubbing or scratching.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others. Unless specifically recited in a claim, steps or components of claims should not be implied or imported from the specification or any other claims as to any particular order, number, position, size, shape, angle, color, or material.

All the patents and applications referred to herein are hereby specifically, and totally incorporated herein by reference in their entirety in the instant specification.

1. A release coating composition comprising:
a crosslinking network of fluorinated organic chains; and
organosilane compounds, wherein the composition comprises fluorine content greater than 50 percent and further wherein the composition does not contain silicon-oxygen bonding.

2. The release coating composition of claim 1, wherein the organosilane compounds are fluorinated or non-fluorinated.

3. The release coating composition of claim 1, wherein the crosslinking network of fluorinated organic chains are connected by silane linkages.

4. The release coating composition of claim 1, wherein the fluorinated organic chains are crosslinked through hydrosilylation reactions to form a crosslinked network.

5. The release coating composition of claim 1, wherein the cross-linking network of fluorocarbons is formed from fluorinated organic chains comprising perfluorobutadiene, perfluorohexadiene, perfluorooctadiene, organosilanes, and mixtures thereof.

6. The release coating composition of claim 1, wherein the fluorine content of the composition is from about 50 to about 70 percent.

7. A fuser member comprising:
a substrate; and
a top-coat layer disposed on the substrate, wherein the top-coat layer comprises
a crosslinking network of fluorinated organic chains; and
organosilane compounds, wherein the top-coat layer comprises fluorine content greater than 50 percent, and further wherein the top-coat layer does not contain silicon-oxygen bonding; wherein the crosslinking network of fluorinated organic chains is free from crosslinkers comprising amino silanes.

8. The fuser member of claim 7, wherein the crosslinking network of fluorinated organic chains are connected by silane linkages.

9. The fuser member of claim 7, wherein the fluorinated organic chains are crosslinked through hydrosilylation reactions to form a crosslinked network.

10. The fuser member of claim 7 further comprising one or more compliant layers between the substrate and top-coat layer.

11. The fuser member of claim 7, wherein the substrate comprises a material selected from the group consisting of silicone, plastic or metal.

12. The fuser member of claim 7, wherein the substrate is in the shape of a roll or a belt.

13. The fuser member of claim 7, wherein the top-coat layer has a thickness of from about 10 μm to about 100 μm.

14. (canceled)

15. The fuser member of claim 7, wherein the fuser member exhibits higher wear resistance and higher chemical and thermal stability during fusing than a fuser member not including the crosslinking network of fluorinated organic chains connected by silane linkages.

16. A method for providing a coating composition for a fuser member, comprising:
providing a perfluorohexadiene and an organic compound having siloxane in the compound in a medium comprising a catalytic amount of a heterogeneous platinum group metal catalyst that is catalytically active towards hydrosilylation;
carrying out the hydrosilylation reaction in the medium; and
removing the catalyst from the medium to produce a composition comprising the hydrosilylation reaction product the perfluorohexadiene and the organic compound having siloxane in the compound.

17. The method of claim 16, further including applying the composition to a fuser member and curing the composition to form a coating composition on the fuser member.

18. The method of claim 16, wherein the applying step is performed by spray coating, dip coating, brush coating, roller coating, spin coating, casting, or flow coating.

19. The method of claim 16, wherein the curing step is performed at a temperature of from about 40° C. to about 400° C.

20. The method of claim 16, wherein the curing step is performed for about 20 to about 300 minutes.

21. The fuser member of claim 7, wherein the amino silanes comprises (N-(2-aminoethyl)-3-aminopropyltrimethoxysilane), 3-(N-strylmethyl-2-aminoethylamino)propyltrimethoxy silane hydrochloride or (aminoethylamino methyl)phenethytrimethoxysilane.
